(19) United States
(12) Patent Application Publication
(10) Pub. No.: US 2006/0074990 A1
(43) Pub. Date: Apr. 6, 2006

(54) Leaf avoidance during garbage collection in a Java Virtual Machine

(75) Inventors: Peter W. Burka, Ottawa (CA); Ryan A. Sciampacone, Nepean (CA); Ronald Servant, Kanata (CA); Karl M. Taylor, Kanata (CA)

Correspondence Address: HOFFMAN, WARNICK & D'ALESSANDRO LLC, 75 STATE ST, 14 FL, ALBANY, NY, 12207, US

(73) Assignee: International Business Machines Corporation, Armonk, NY (US)

(21) Appl. No.: 10/951,427

(22) Filed: Sep. 28, 2004

(51) Int. Cl. G06F 17/30

(52) U.S. Cl. 707/200

(57) ABSTRACT

A system, method and program product for optimizing the mark phase of garbage collection in a JVM. A garbage collector is provided for removing unused objects, wherein the garbage collector includes: a traversing system for traversing object fields in objects obtained from a work queue, wherein the traversing system includes a leaf identifying system for determining whether object fields contain a leaf node; and a marking system for marking objects as live.

### FIELD OF THE INVENTION

The present invention relates generally to garbage collection in a Java Virtual Machine (JVM), and relates more specifically to a system and method for avoiding leaves during garbage collection in a JVM.

### RELATED ART

In Java Virtual Machines (JVM) and other similar run-time environments, objects that are no longer referenced must be regularly cleaned up using what is commonly referred to as garbage collection. A common garbage collection technique is known as “mark and sweep.” During the mark phase, every reachable object must be “marked,” indicating that it is live. Objects are marked by marking a set of “root” objects, and recursively traversing each of these marked objects to mark each of the objects they in turn refer to.

While this recursive process is fairly straightforward, it tends to be a fairly time-consuming task, as hundreds of thousands of objects may need to be traversed. Unfortunately, no solutions exist for reducing the number of objects which must be traversed. Accordingly, a need exists for an optimization to reduce the number of objects which must be traversed, thus accelerating the mark phase of a mark and sweep garbage collector.

### SUMMARY OF THE INVENTION

The present invention addresses the above-mentioned problems, as well as others, by providing a garbage collection system and method that determines if an object is a leaf object during the mark phase. If the object is determined to be a leaf object, then the object is not further examined as part of the traversal process.

In a first aspect, the invention provides a computer system having a garbage collector for removing unused objects, wherein the garbage collector includes: a traversing system for traversing object fields in objects obtained from a work queue, wherein the traversing system includes a leaf identifying system for determining whether object fields contain a leaf node; and a marking system for marking objects as live.

In a second aspect, the invention provides a program product stored on a recordable medium for providing garbage collection, the program product comprising: program code configured for traversing object fields in objects obtained from a work queue; program code configured for determining whether object fields contain leaf objects; and program code configured for marking objects as live.

In a third aspect, the invention provides a method for providing garbage collection in a Java Virtual Machine, comprising: fetching an object from a work queue; fetching a field description for the object; determining if the field description is for a scalar value; if it is not for a scalar value, determining if the field value is a special type; if it is not a special type, marking the object as live if the object is not already marked; determining if the field description is for a leaf field; and only adding the object to the work queue if the field description is not for a leaf field.

In a forth aspect, the invention provides a method for deploying an application for providing garbage collection in a Java Virtual Machine, comprising: providing a computer infrastructure being operable to: traverse object fields in objects obtained from a work queue; determine whether object fields contain a leaf node; and mark objects as live.

In a fifth aspect, the invention provides computer software embodied in a propagated signal for providing garbage collection, the computer software comprises instructions to cause a computer system to perform the following functions: traverse object fields in objects obtained from a work queue; determine whether object fields contain a leaf node; and mark objects as live.

### BRIEF DESCRIPTION OF THE DRAWINGS

These and other features of this invention will be more readily understood from the following detailed description of the various aspects of the invention taken in conjunction with the accompanying drawings in which:

FIG. 1 depicts a system a computer system having a garbage collector in accordance with an embodiment of the present invention.

FIG. 2 depicts a flow chart of a method of implementing a mark phase of garbage collection in accordance with an embodiment of the present invention.

FIG. 3 depicts a flow chart of steps taken at the beginning of a garbage collection process in accordance with an embodiment of the present invention.

FIG. 4 depicts a flow chart of steps taken when a new class is loaded in accordance with an embodiment of the present invention.

The drawings are not necessarily to scale. The drawings are merely schematic representations, not intended to portray specific parameters of the invention. The drawings are intended to depict only typical embodiments of the invention, and therefore should not be considered as limiting the scope of the invention. In the drawings, like numbering represents like elements.

### DESCRIPTION OF THE INVENTION

As discussed above, during a mark phase of a Java Virtual Machine (JVM) garbage collection process, objects (beginning with a set of root objects) are traversed and marked, indicating that each marked object is live. Thus, during the mark phase, each object in the “root set” is marked. Also, each object referenced by a marked object is marked, until all reachable objects have been marked. Objects are traversed by examining the fields in the object to determine if the field is an object field. If the field is an object field and the value in the field has not yet been marked, then the value in that field is marked and the value is added to a work queue so that it can be later traversed. While the present invention is generally described with reference to a JVM environment, it is understood that the application can apply to any similar object-oriented runtime environment or system that utilizes garbage collection.

In a JVM environment, certain classes of objects cannot contain references to other objects. These include primitive array classes (e.g., arrays of bytes—byte[]) and final classes with no object instance variables (e.g., java.lang.Byte). Instances of these classes must be marked (so that they are not misidentified as garbage and recycled), but there is no need to traverse them, since they are leaves in the object graph—traversing them could not lead to the discovery of additional objects. For the purposes of this invention, these objects are referred to as “leaf objects” or “leaf nodes.”

In accordance with this invention, the garbage collector determines that particular fields may only refer to leaf objects. The garbage collector avoids traversing these objects, or even inspecting the objects' headers. This reduces the working set of memory pages that are used during the mark phase of a garbage collection, resulting in reduced memory cache misses.

The objects in the heap of a JVM can be considered to be a directed graph. Object instances make up the nodes of the graph, and references from one object to another make up the vertices. Objects which do not refer to any other objects are leaf nodes. For the purposes of such a graph, the reference from each object to its class object will not be considered as vertices. Although any object may be a leaf node, certain classes of objects are constrained to only form leaf nodes.

There are four categories of classes that can only form leaf nodes:
1. Primitive arrays. Arrays of scalar types (int, long, byte, short, char, boolean, float or double) cannot refer to other objects.

2. Final leaf classes. Final classes are classes which may not be subclassed. Instances of a final class which neither defines nor inherits any reference-type fields can only be leaf nodes.
3. Extendable leaf classes. Extendable classes are any classes which may be subclassed. An extendable class is considered to be a leaf class if it does not define or inherit any reference-type fields, and if all of its subclasses are leaf types.
4. Leaf interfaces. An interface is considered to be a leaf type if all classes which implement the interface, whether directly or through inheritance, are leaf classes.

An important property of leaf classes is that all subclasses (if any) of the leaf class are also leaf classes. In addition, all implementors of a leaf interface are leaf classes. Disregarding class redefinitions (which may only be introduced through a debugging interface), being a primitive array or a final leaf class is an immutable property of a class, while being an extendable leaf class or a leaf interface is a mutable property. As more classes are loaded into the system, non-leaf subclasses may be introduced, invalidating the conditions for a super-class being a leaf class.

The precise type of any object in the heap can only be determined by inspecting the object's header. However, certain information about the type of an object may be inferred without inspecting the object's header. In particular, any object referred to by a field from another object must conform to the constraints imposed on it by the type of that field. Every object field has a type associated with it. Any object stored in a field must be an instance of the type or an instance of a subclass of the type, or, if the type is an interface, an instance of a class which implements the interface.

A field can be shown to only contain a leaf type by examining the signature of the field. The signature is a string which describes the name and type of the field. The JVM runtime guarantees that all objects which may be stored in the field are constrained to be compatible with the type of the field. Because of the properties of leaf types described above, the garbage collector can therefore infer that, if the type of the field is a leaf type then the field may only refer to leaf objects.

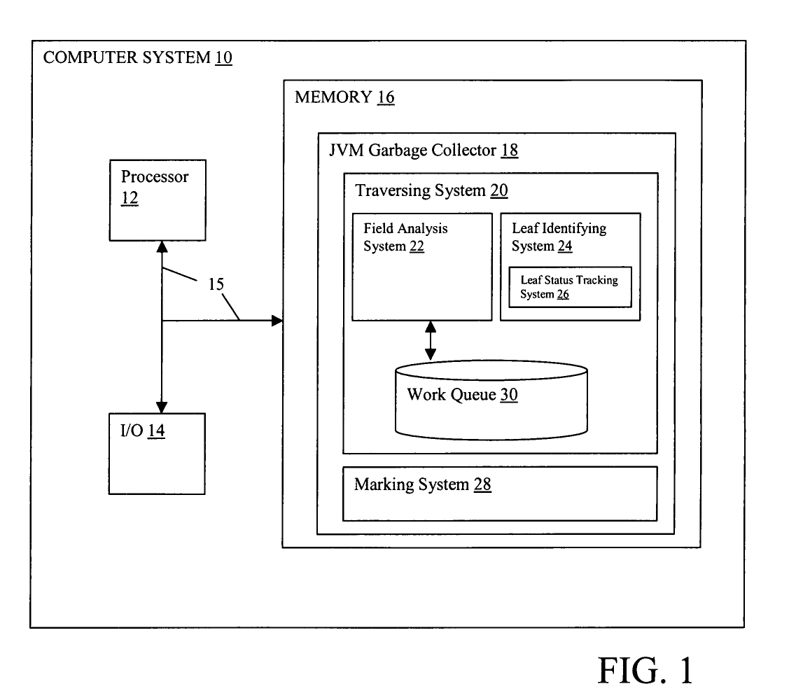

Referring now to FIG. 1, an illustrative embodiment of the invention is shown incorporated into a computer system 10. Computer system 10 may be any type of computerized system capable of carrying out the teachings of the present invention. For example, computer system 10 could be a desktop computer, laptop computer, a workstation, a server, a handheld device, etc. As depicted, computer system 10 generally includes processing unit 12, memory 16, a bus 15, and input/output (I/O) interfaces 14. Processing unit 12 may comprise a single processing unit, or be distributed across one or more processing units in one or more locations, e.g., on a client and server. Memory 16 may comprise any known type of data storage and/or transmission media, including magnetic media, optical media, random access memory (RAM), read-only memory (ROM), a data cache, a data object, etc. Moreover, similar to processing unit 12, memory 16 may reside at a single physical location, comprising one or more types of data storage, or be distributed across a plurality of physical systems in various forms.

I/O interfaces 14 may comprise any system for exchanging information to/from an external resource (not shown). External resources may for example comprise any known type of external device, including a storage unit, speakers, a CRT, LED screen, hand-held device, keyboard, mouse, voice recognition system, speech output system, printer, monitor/display, facsimile, pager, etc. Bus 15 provides a communication link between each of the components in computer system 10 and likewise may comprise any known type of transmission link, including electrical, optical, wireless, etc. Although not shown, additional components, such as cache memory, communication systems, system software, etc., may be incorporated into computer system 10.

Shown in memory 16 as a program product is an illustrative JVM garbage collector 18. In order to implement the marking phase of garbage collection, garbage collector 18 includes: (1) a traversing system 20 for recursively traversing objects from the work queue 30; and (2) a marking system 28 for marking objects located by the traversing system 20. In this illustrative embodiment, traversing system 20 includes a field analysis system 22 that determines whether fields in an object are object fields. Traversing system 20 further includes a leaf identifying system 24 that determines whether an identified object field is one that can only contain leaf objects. If leaf identifying system 24 identifies an object field as such, then the value in the object field is not added to the work queue 30. Alternatively, if leaf identifying system 24 determines that the object field is not one that can only contain leaf objects, then the value in the object field is added to the work queue 30 to be traversed.

As noted above, leaf identifying system 24 determines whether the object field is a leaf type by examining the signature of the field. The signature is a string which describes the type of the field. Thus, in order to identify a primitive array, leaf identifying system 24 need only determine whether the string being examined matches one that is allowed for describing a primitive array, e.g., “[B,” “[I,” etc. Moreover, because primitive arrays are the only types that can be named with a two byte identifier in the JVM runtime environment, leaf identifying system 24 need only determine if the string contains exactly two bytes. If the string contains only two bytes, then it is known that the string names a primitive array, which is a leaf type.

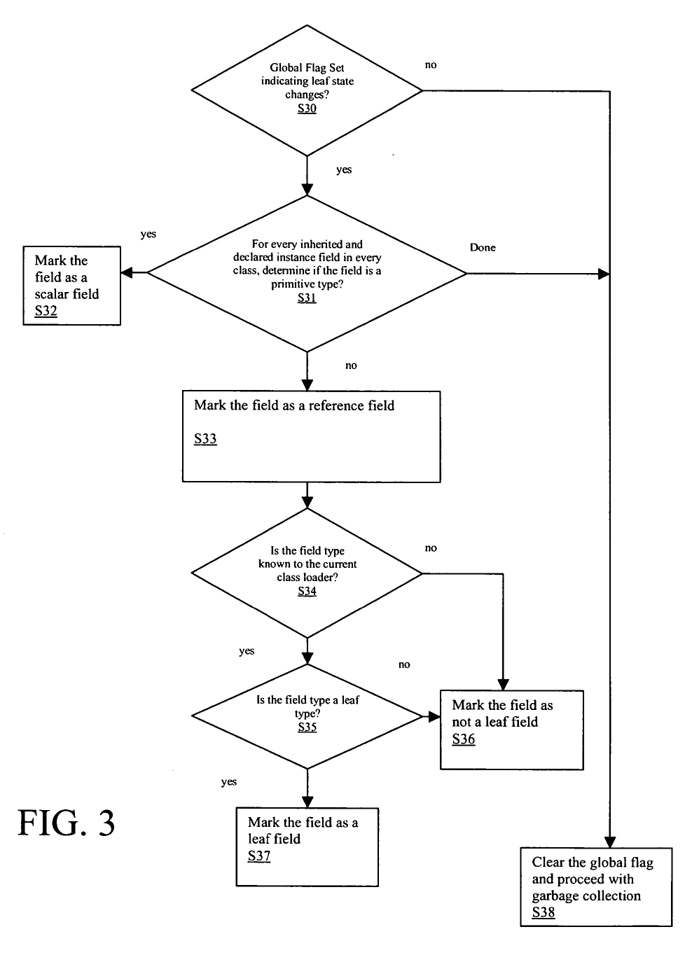

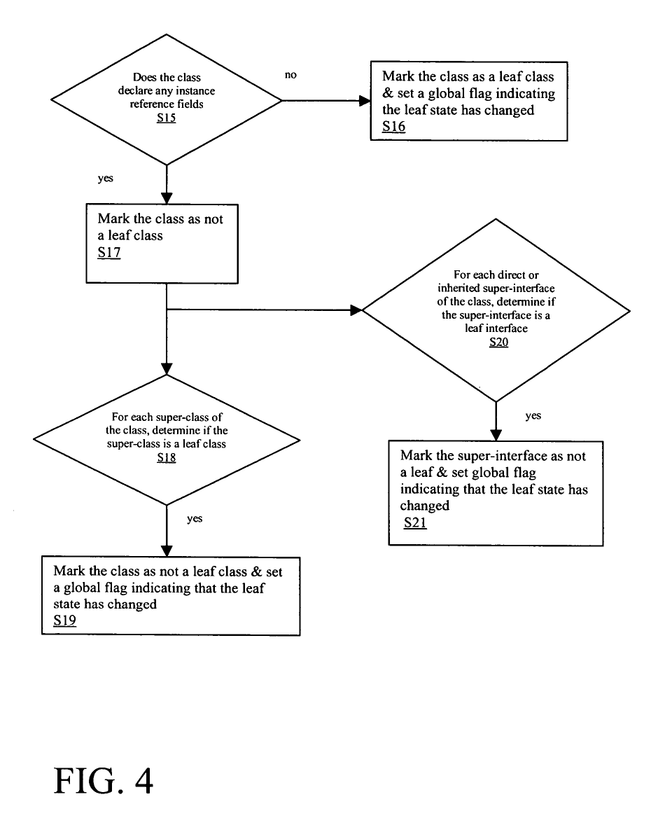

For the other possible leaf node types (i.e., final leaf classes, extendable leaf classes, and leaf interfaces), similar tests can be implemented. In these non-primitive-array cases, leaf status tracking system 26 may be utilized to dynamically track the status of the node, as the status may change over time. An illustrative implementation of such a system is described below with reference to FIGS. 3 and 4.

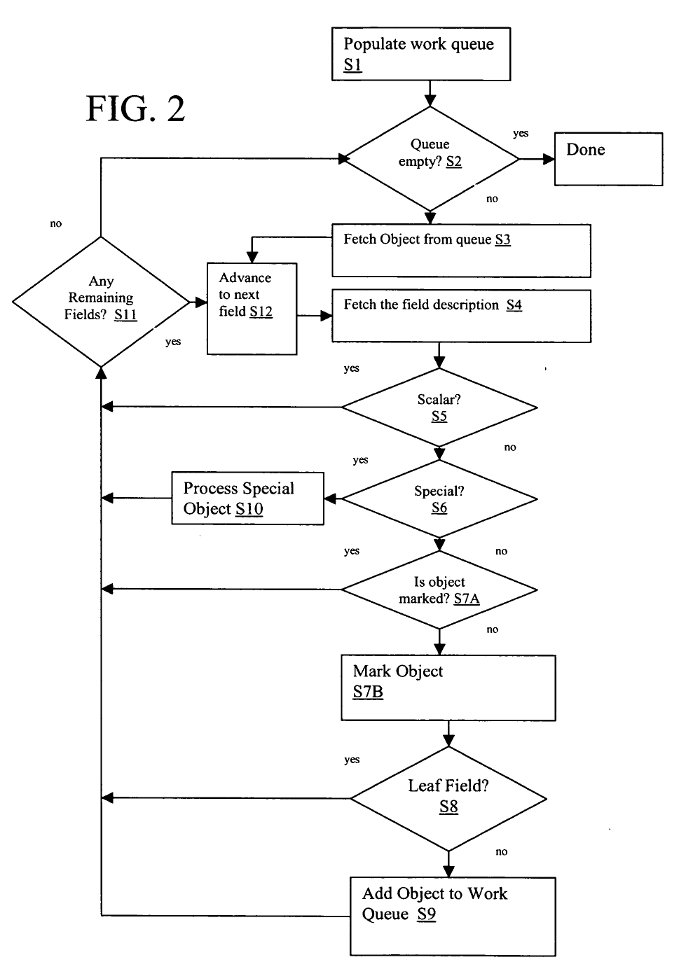

FIG. 2 depicts a flow chart of an illustrative method of implementing a mark phase of garbage collection in accordance with the invention. At step S1, the process begins by populating the work queue with all of the root objects. At step S2, a determination is made whether the queue is empty. If it is empty, the process is complete. If it is not empty, then, at step S3, a next object is fetched from the queue, and at step S12, a pointer advances to the next field (initially it will point to the first field in the object). At step S4, the field description is fetched and at step S5 a determination is made whether the field is for a scalar type. If it is not scalar, then at step S6, a determination is made whether the value stored in the field is special (e.g., a class), and if it is, the object is processed as special at step S10. At steps S7A and S7B, if it is not special, then the value stored in the field is marked if it was not already marked. If the value stored in the field was already marked, the process loops to step S11. At step S8, a determination is made whether the field is a leaf field, and if it is not a leaf field, then the object is added to the work queue at step S9. If the field is a leaf field, then the object is not added to the work queue. The process loops at step S11 by determining if there are any remaining fields.

This process of determining whether a field is a leaf may be implemented by storing extra information in the class's field description data. Instead of simply distinguishing between object and non-object fields, a third type can be added, i.e., a “leaf object.”

As noted above, in the event that leaf identifying system 24 (FIG. 1) is implemented to identify non-primitive-array type leaf nodes, then tracking system 26 must be implemented to track the “leaf status” or state of classes over time. This process can be implemented in any fashion. FIGS. 3 and 4 describe one possible method.

FIG. 3 depicts the steps that are performed at the beginning of each garbage collection cycle. In this illustrative embodiment, a global flag is checked at step S30 that indicates whether leaf-state changes have occurred. If they have occurred, then at step S31, for every inherited and declared instance field for every class, a check is made to see if the field is of a primitive type. If it is, the field is marked as a scalar at step S32. If it is not, then the field is marked as a reference field at step S33. Next, at steps S34 and S35, a check is made whether the type of the field is known to the current class loader and if so, whether the type of the field is a leaf type. If either inquiry results in a “no,” then the field is marked as not a leaf field at step S36. Otherwise, the field is marked as a leaf field at step S37. Finally, after all the instance fields in all the classes have been checked (or the global flag was not initially set at step S30), the global flag is cleared at step S38, and garbage collection can proceed.

Each time a new class is loaded, the leaf status of the new class must be initialized and the leaf status of any classes affected by the load must be updated. This process is shown in FIG. 4. First, at step S15, a determination is made whether the class declares any instance reference fields. If it does not, the class is marked as a leaf class and the global flag is set indicating that the leaf state has changed at step S16. If it does, then the class is marked as not a leaf class at step S17. Then, for each super-class of the class, a determination is made whether the super-class is currently marked as being a leaf class at step S18. If a super-class is marked as a leaf class, then the super-class is re-marked as not a leaf class, and the global flag is set indicating that the leaf state has changed at step S19. If the class is not a leaf class, then for each direct or inherited super-interface of the class, a determination is made at step S20 whether the super-interface is currently marked as being a leaf interface. If it is, then the super-interface is re-marked as not a leaf and the global flag is set indicating that the leaf state has changed at step S21.

It should be appreciated that the teachings of the present invention could be offered as a business method on a subscription or fee basis. For example, computer system 10 of FIG. 1 could be created, maintained, supported and/or deployed by a service provider that offers the functions described herein for customers. That is, a service provider could offer to generate and display a logical structure of nodes as described above.

It should also be understood that the present invention can be realized in hardware, software, a propagated signal, or any combination thereof. Any kind of computer/server system(s)—or other apparatus adapted for carrying out the methods described herein—is suited. A typical combination of hardware and software could be a general purpose computer system with a computer program that, when loaded and executed, carries out the respective methods described herein. Alternatively, a specific use computer, containing specialized hardware for carrying out one or more of the functional tasks of the invention, could be utilized. The present invention can also be embedded in a computer program product or a propagated signal, which comprises all the respective features enabling the implementation of the methods described herein, and which—when loaded in a computer system—is able to carry out these methods. Computer program, propagated signal, software program, program, or software, in the present context mean any expression, in any language, code or notation, of a set of instructions intended to cause a system having an information processing capability to perform a particular function either directly or after either or both of the following: (a) conversion to another language, code or notation; and/or (b) reproduction in a different material form.

The foregoing description of the preferred embodiments of this invention has been presented for purposes of illustration and description. It is not intended to be exhaustive or to limit the invention to the precise form disclosed, and obviously, many modifications and variations are possible. Such modifications and variations that may be apparent to a person skilled in the art are intended to be included within the scope of this invention as defined by the accompanying claims.

1. A computer system having a garbage collector for removing unused objects, wherein the garbage collector includes:
a traversing system for traversing object fields in objects obtained from a work queue, wherein the traversing system includes a leaf identifying system for determining whether object fields contain a leaf node; and
a marking system for marking objects as live.

2. The computer system of claim 1, wherein the garbage collector is part of a Java Virtual Machine.

3. The computer system of claim 1:
wherein the leaf identifying system examines a signature of the object field to identify leaf nodes; and
wherein objects identified as leaf nodes are not marked as live by the marking system.

4. The computer system of claim 3, wherein the leaf identifying system identifies primitive arrays as leaf nodes.

5. The computer system of claim 4, wherein primitive arrays are identified as having a two byte field signature.

6. The computer system of claim 1, wherein the leaf identifying system identifies leaf nodes selected from the group consisting of: final leaf classes, extendable leaf classes, and leaf interfaces.

7. The computer system of claim 6, wherein the leaf identifying system includes a leaf status tracking system for tracking a leaf state of any classes affected by a new class load.

8. A program product stored on a recordable medium for providing garbage collection, the program product comprising:
program code configured for traversing object fields in objects obtained from a work queue;
program code configured for determining whether object fields contain leaf objects; and
program code configured for marking objects as live objects.

9. The program product of claim 8, wherein the program product comprises a Java Virtual Machine.

10. The program product of claim 8:
wherein the program code configured for determining whether object fields contain leaf objects examines a signature of the object field to identify leaf objects; and
wherein objects identified as leaf objects are not marked as live objects.

11. The program product of claim 10, wherein the program code configured for determining whether object fields contain leaf objects identifies primitive arrays as leaf objects.

12. The program product of claim 11, wherein primitive arrays are identified as having a two byte field signature.

13. The program product of claim 8, wherein the program code configured for determining whether object fields contain leaf objects identifies leaf objects selected from the group consisting of instances of: final leaf classes, extendable leaf classes, and leaf interfaces.

14. The program product of claim 13, wherein the program code configured for determining whether object fields contain leaf objects includes a leaf status tracking system for tracking a leaf state of any classes affected by loading a new class.

15. A method for providing garbage collection in a Java Virtual Machine, comprising:
fetching an object from a work queue;
fetching a field description for the object;
determining if the field description is for a scalar value;
if it is not for a scalar value, determining if the field value is a special type;
if it is not a special type, marking the object as live if the object is not already marked;
determining if the field description is for a leaf field; and
only adding the object to the work queue if the field description is not for a leaf field.

16. The method of claim 15, wherein the step of determining if the field description is for a leaf field comprises examining a signature of the field.

17. The method of claim 15, wherein the step of determining if the field description is for a leaf field comprises identifying fields for holding primitive arrays as leaf fields.

18. The method of claim 17, wherein primitive arrays are identified as having a two byte field signature.

19. The method of claim 15, wherein the step of determining if the field description is for a leaf field comprises identifying fields which contain objects selected from the group consisting of instances of: final leaf classes, extendable leaf classes, and leaf interfaces.

20. The method of claim 19, wherein the step of determining if the field description is for a leaf field comprises tracking a leaf state of any classes affected by loading a new class.

21. A method for deploying an application for providing garbage collection in a Java Virtual Machine, comprising:
providing a computer infrastructure being operable to:
traverse object fields in objects obtained from a work queue;
determine whether object fields contain a leaf node; and
mark objects as live.

22. Computer software embodied in a propagated signal for providing garbage collection, the computer software comprises instructions to cause a computer system to perform the following functions:
traverse object fields in objects obtained from a work queue;
determine whether object fields contain a leaf node; and
mark objects as live.
